(19) United States
(12) Patent Application Publication
(10) Pub. No.: US 2015/0117011 A1
(43) Pub. Date: Apr. 30, 2015

(54) LASER EMITTING DEVICE

(71) Applicant: Arima Lasers Corp., Taoyuan County (TW)

(72) Inventors: Ming-Cho WU, Taoyuan County (TW); Ching-Hui LIN, Taipei City (TW); Cheng-Tsung TSENG, Taoyuan County (TW); CHUI-YAO CHIU, Taoyuan County (TW); Ming-June CHIEN, Taoyuan County (TW)

(73) Assignee: Arima Lasers Corp., Taoyuan County (TW)

(21) Appl. No.: 14/217,423

(22) Filed: Mar. 17, 2014

(30) Foreign Application Priority Data
Oct. 30, 2013 (TW) 102220207

(51) Int. Cl. F21K 99/00

(52) U.S. Cl. CPC F21K 9/54
USPC 362/259

(57) ABSTRACT

A laser emitting device includes a laser plane source for providing planar surrounding light, a reflector, and a connection mechanism. The reflector surrounds the laser plane source and has a reflective sidewall facing the laser plane source. The reflective sidewall includes a plurality of reflective surfaces connected to each other. Each of the reflective surfaces has an individual angle relative to the planar surround light. The planar surrounding light hits one of the reflective surfaces and forms a laser ring emitted from the laser emitting device. The connection mechanism allows the reflector to be moved relative to laser plane source. A size of the laser ring can be changed by changing the reflective surface to be hit.

### RELATED APPLICATIONS

This application claims priority to Taiwan Application Serial Number 102220207, filed Oct. 30, 2013, which is herein incorporated by reference.

### BACKGROUND

1. Field of Invention

The present invention relates to a light emitting device. More particularly, the present invention relates to laser emitting device.

2. Description of Related Art

With the development of science and technology, projectors have been applied to a fairly wide range of products, ranging from consumer products to high-tech products, since their introduction. For example, a projector is applied to a conference speech to enlarge the subject matters by projection. Or, a projector is applied to a commercial projection screen or a television to show real-time pictures in conjunction with contents of presentation.

When a presentation is performed, auxiliary tools, such as a laser pointer, are often utilized to attract the attention of viewers toward the presentation objects. However, a beam spot emitted from a traditional laser pointer will diverge with distance. Such a diverging beam spot will block clear viewing of the aimed presentation objects. In addition, because the light beam emitted by the laser pointer has a concentrated high energy distribution, injury to people is likely to be caused if the laser beam is swept across eyes of other persons inadvertently by the user. On the other hand, transformation of typical Gaussian laser beams into other distribution such as Bessel-Gaussian beam is well known in applications such as laser machining. A common method is to use the combination of Axicon lens and other optical components to form ring-shape intensity distribution. Another alternative is to employ diffractive optical elements to generate a ring-shape intensity distribution. However, the known methods suffer defects as only being capable of generating usable laser ring over limited distance or causing too much intensity loss during the beam transformation. An object of the present invention is to improve the quality and efficiency of generating laser light having ring-shape intensity distribution.

### SUMMARY

The present invention provides a laser emitting device to solve the problem that a bright beam spot emitted from a laser pointer blocks clear viewing of aimed presentation objects by providing a novel method to generate ring-shape laser distribution.

The laser emitting device comprises a laser plane source, a reflector, and a connection mechanism. The laser plane source serves to provide planar surrounding light. The planar surrounding light has a normal direction which is along the beam emission direction of said leaser emitting device. The reflector surrounds the laser plane source. The reflector has a reflective sidewall facing the laser plane source. The reflective sidewall comprises a plurality of reflective surfaces connected to each other. Each of the reflective surfaces has an individual angle relative to the normal direction. The connection mechanism allows the reflector to be moved relative to the laser plane source along the normal direction.

In the foregoing, the laser plane source comprises a laser diode and a cone lens disposed in a light-emitting direction of the laser diode.

In the foregoing, the laser plane source comprises a laser diode and an optical device. The optical device comprises a cone cavity.

In the foregoing, the laser plane source comprises a plurality of laser diodes and a plurality of diverging devices disposed corresponding to the plurality of laser diodes. The plurality of diverging devices and the plurality of laser diodes are coplanar to allow light beams emitted from the plurality of laser diodes to constitute the planar surrounding light after passing through the plurality of diverging devices.

In the foregoing, the laser plane source comprises a plurality of laser diodes, a plurality of diverging devices disposed corresponding to the plurality of laser diodes, and a plurality of reflective mirrors disposed corresponding to the plurality of diverging devices. Light beams emitted from the plurality of laser diodes constitute the planar surrounding light after passing through the plurality of diverging devices and the plurality of reflective mirrors.

In the foregoing, the angles between the plurality of reflective surfaces and the normal direction gradually increase from one end adjacent to the laser plane source to the other end.

In the foregoing, the angles between the plurality of reflective surfaces and the normal direction gradually decrease from one end adjacent to the laser plane source to the other end.

In the foregoing, the laser emitting device further comprises a housing having a battery receiving cavity, a partition board covering the battery receiving cavity, and a conductive spring. The conductive spring is disposed on a surface of the partition board facing the battery receiving cavity. The laser plane source is fixed on another surface of the partition board and electrically connected to the conductive spring.

In the foregoing, the connection mechanism slidably connects the reflector and the housing.

In the foregoing, the laser emitting device is a lighting apparatus, a laser pointer, or a warning device.

In the foregoing, the reflector is in a shape of a cup.

In the foregoing, the planar surrounding light is distributed in a horizontal plane.

In the foregoing, the laser plane source comprises a laser diode, a reflective lens, and a collimating lens. The reflective lens comprises a cone cavity, and a hole formed at a center of a bottom of the reflective lens, in which the hole is led to the cone cavity. The collimating lens is disposed between the laser diode and the reflective lens.

The present invention provides a laser emitting device. The laser emitting device comprises a laser diode, a reflective lens, and a collimating lens. The reflective lens comprises a cone cavity, a hole formed at a center of a bottom of the reflective lens, wherein the hole is led to the cone cavity, an inclined side surface, and a reflective layer coated on the inclined side surface. The collimating lens is disposed between the laser diode and the reflective lens.

The present invention provides a laser emitting device. The laser emitting device comprises a laser plane source serving to provide planar surrounding light, a reflector, and a connection mechanism. The reflector surrounds the laser plane source. The reflector has a reflective sidewall facing the laser plane source. The reflective sidewall comprises a plurality of reflective surfaces connected to each other. Each of the reflective surfaces has an individual angle relative to the planar surrounding light. The planar surrounding light hits one of the reflective surfaces and forms a laser ring emitted from the laser emitting device. The connection mechanism allows the reflector to be moved relative to the laser plane source. A size of the laser ring is changed by changing the reflective surface to be hit.

In the foregoing, the planar surrounding light is distributed in a horizontal plane or in a conical shape.

Another aspect of the laser emitting device includes a laser plane source providing planar surrounding light, a reflector, and a connection mechanism. The reflector surrounds the laser plane source and has a reflective sidewall facing the laser plane source. The reflective sidewall comprises a reflective surface having an angle relative to the planar surrounding light, and the planar surrounding light hits the reflective surface and forms a laser ring emitted from the laser emitting device. The connection mechanism connects the laser plane source to the reflector.

The present invention laser emitting device can be used alone, or a combination of a plurality of laser emitting devices can be used. The laser emitting device may be applied to lighting apparatuses, such as lamps and lanterns, decorative lights, or electric hand torches. The laser emitting device may also be applied to laser pointers to resolve the problem that a bright beam spot blocks clear viewing of aimed objects when the projection distance increases which always happens in the prior art laser pointer. The laser emitting device may also be applied to warning devices. For example, the laser emitting device may be applied to a bicycle so as to project a flashing laser ring having approximately the same width or length as that of the bicycle on the ground. As a result, vehicle drivers are alerted to the presence of bicycle rider during night time.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention. The drawings illustrate embodiments of the invention and, together with the description, serve to explain the principles of the invention. In the drawings,

FIG. 1A and FIG. 1B are cross-sectional views of a laser emitting device in different operation states according to one embodiment of this invention;

FIG. 2 is a pattern of planar surrounding light after being reflected by a reflector;

FIG. 3 to FIG. 6 are schematic diagrams of a laser plane source of a laser emitting device according to different embodiments of this invention;

FIG. 7A and FIG. 7B are schematic cross-sectional views of a reflector of the laser emitting device in FIG. 1A according to different embodiments of this invention;

FIG. 8A to FIG. 8C are schematic diagrams of optical paths when planar surrounding light in a laser emitting device irradiates on reflective surfaces having different angles according to this invention; and

FIG. 9A to FIG. 9D are respectively schematic diagrams of the laser plane source in FIG. 4 according to different embodiments.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

It will be apparent to those skilled in the art that, after having an understanding of the preferred embodiments of the present invention, various modifications and variations can be made to the structure of the present invention based on the teaching of the present invention without departing from the scope or spirit of the invention.

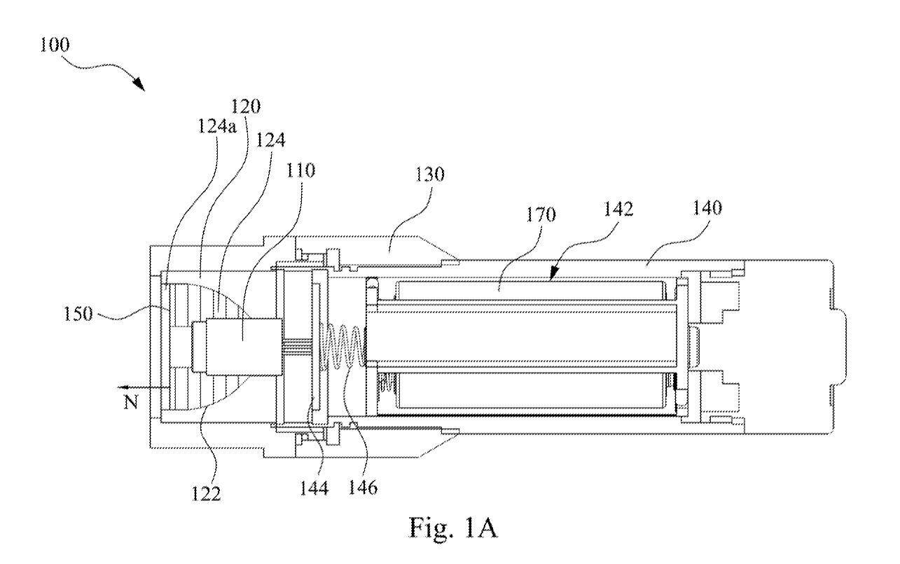

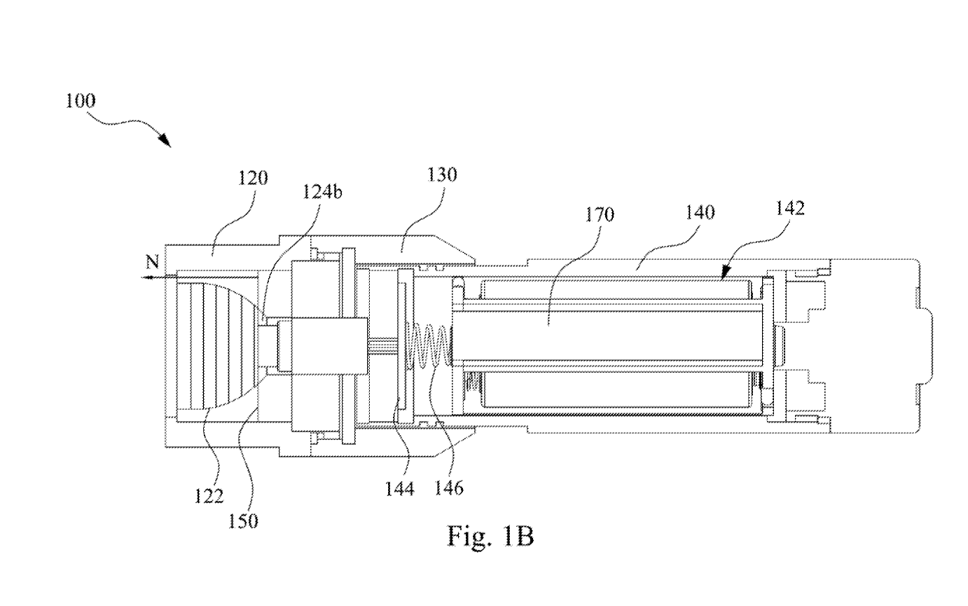

FIG. 1A and FIG. 1B are cross-sectional views of a laser emitting device in different operation states according to one embodiment of this invention. The laser emitting device 100 comprises a laser plane source 110, a reflector 120, and a connection mechanism 130, and a housing 140.

The laser plane source 110 serves to provide planar surrounding light 150. The planar surrounding light 150 has a normal direction N. The normal direction N is approximately a light-emitting direction of the laser emitting device 100.

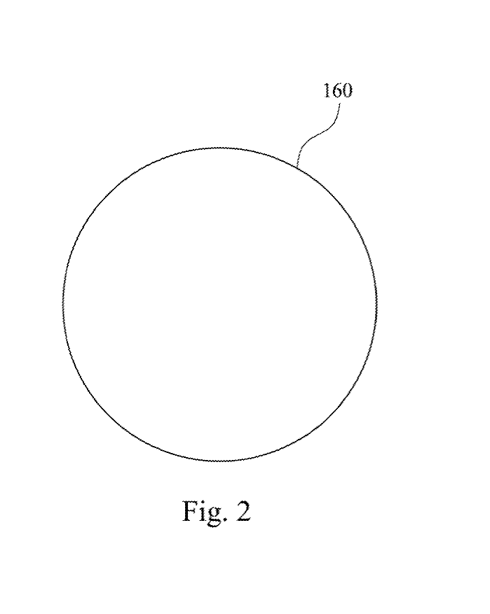

The reflector 120 surrounds the laser plane source 110. The reflector has a reflective sidewall 122 facing the laser plane source 110. The reflector 120 is approximately in a shape of a cup. The laser plane source 110 is disposed in the cup-like reflector 120. The planar surrounding light 150 provided by the laser plane source 110 is first reflected by the reflective sidewall 122 of the reflector 120, and then emitted out of an opening of the cup-like reflector 120. The planar surrounding light 150 after being reflected by the reflector 120 is emitted and forms a laser ring 160 as shown in FIG. 2.

The reflective sidewall 122 of the reflector 120 comprises a plurality of reflective surfaces 124 connected to each other. Each of the reflective surfaces 124 has an individual angle relative to the normal direction N.

The connection mechanism 130 slidably connects the reflector 120 and the housing 140 so that the reflector 120 is allowed to move relative to the laser plane source 110 along the normal direction N. For example, the opening of the reflector 120 in FIG. 1A is closer to the laser plane source 110, and the opening of reflector 120 in FIG. 1B is farther away from the laser plane source 110.

By changing a position of the reflector 120 relative to the laser plane source 110, the reflective surface 124 to be hit by the planar surrounding light 150 provided by the laser plane source 110 will be different. For example, the planar surrounding light 150 in FIG. 1A irradiates on a reflective surface 124a, and the planar surrounding light 150 in FIG. 1B irradiates on a reflective surface 124b.

Because each of the reflective surfaces 124 has its individual angle relative to the normal direction N, a size of the laser ring 160 formed by hitting the planar surrounding light 150 on the different reflective surfaces 124 will vary. Users are thus able to adjust the position of the reflector 120 relative to the laser plane source 110 based on their respective requirements so as to change the size of the laser ring 160.

The housing 140 of the laser emitting device 100 has a battery receiving cavity 142 for accommodating a battery 170. The laser emitting device 100 further comprises a partition board 144 and a conductive spring 146. The partition board 144 covers the battery receiving cavity 142. The battery 170 and the laser plane source 110 are respectively positioned on two opposite sides of the partition board 144. The conductive spring 146 is disposed on a surface of the partition board 144 facing the battery receiving cavity 142. The laser plane source 110 is fixed on another surface of the partition board 144 and electrically connected to the conductive spring 146. In other words, the laser plane source 110 is electrically connected to the battery 170 through the conductive spring 160.

The laser plane source utilized in the present invention may comprise any design being able to provide planar surrounding light. A number of embodiments are shown as follows by way of illustration. However, it should be understood that such description is only to illustrate and not to limit the scope of the invention.

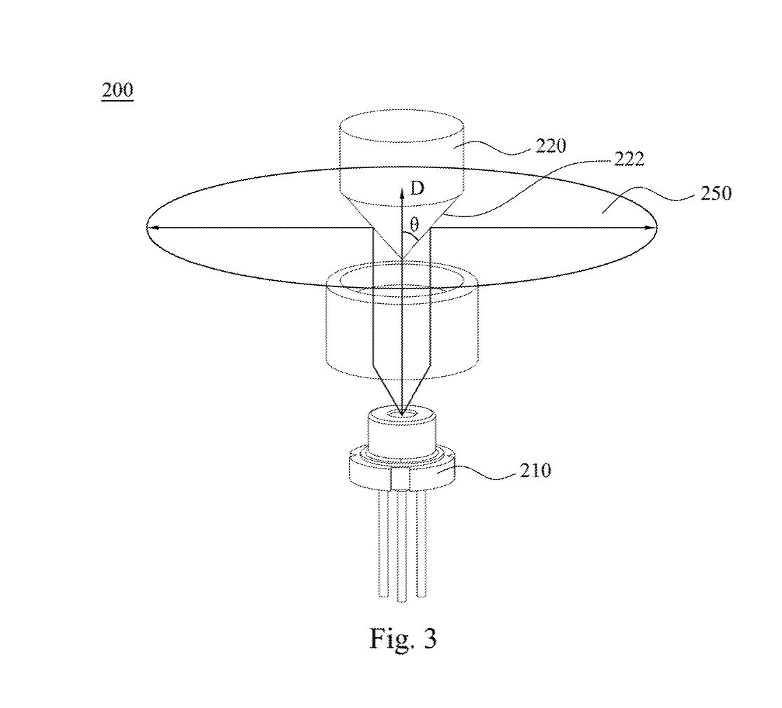

FIG. 3 is a schematic diagram of a laser plane source of a laser emitting device according to one embodiment of this invention. The laser plane source 200 comprises a laser diode 210 and a cone lens 220. The laser diode 210 has a light-emitting direction D. The light-emitting direction D is approximately parallel with the normal direction N shown in FIG. 1A. The cone lens 220 is disposed in the light-emitting direction D of the laser diode 210. The cone lens 220 is in a shape of a cone. A tip of the cone lens 220 points to the laser diode 210. A side 222 of the cone lens 220 has a high reflectivity so that laser beams emitted from the laser diode 210 first irradiate on the side 222 of the cone lens 220 and then are reflected to form planar surrounding light 250.

An angle θ is formed between the side 222 of the cone lens 220 and the light-emitting direction D of the laser diode 210. When the angle θ between the side 222 and the light-emitting direction D is approximately 45 degrees, light beams emitted from the laser diode 210 become the planar surrounding light 250 after being reflected by the side 222 of the cone lens 220. The planar surrounding light 250 is distributed in a horizontal plane. After the planar surrounding light 250 distributed in a horizontal plane irradiates on one of the reflective surfaces 124 shown in FIG. 1A, the laser ring 160 shown in FIG. 2 is obtained.

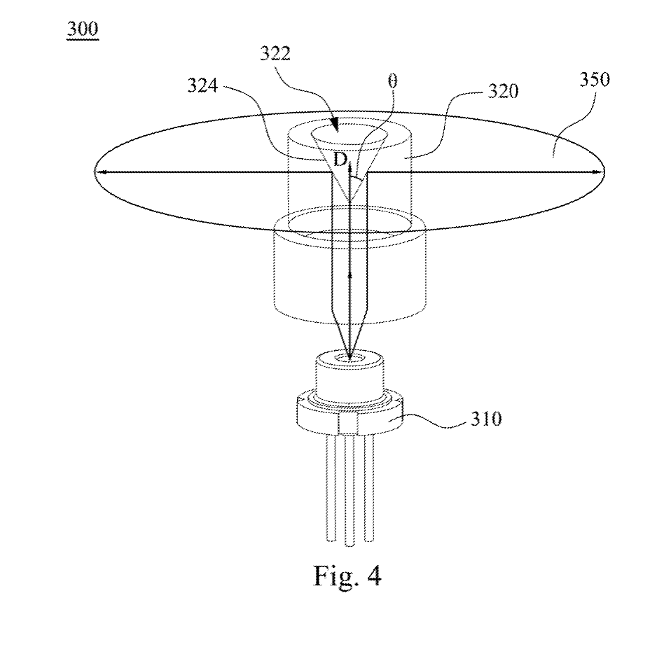

FIG. 4 is a schematic diagram of a laser plane source of a laser emitting device according to another embodiment of this invention. The laser plane source 300 comprises a laser diode 310 and an optical device 320. The laser diode 310 has a light-emitting direction D. The light-emitting direction D is approximately parallel with the normal direction N shown in FIG. 1A. The optical device 320 is disposed in the light-emitting direction D of the laser diode 310. The optical device 320 has a cone cavity 322. A tip of the cone cavity 322 points to the laser diode 310. A portion of the optical device 320 defining a sidewall 324 of the cone cavity 322 has a high reflectivity or a predetermined inclined angle, so that laser beams emitted from the laser diode 310 first irradiate on the sidewall 324 and then are reflected to form planar surrounding light 350.

Similarly, when an angle θ between the sidewall 324 and the light-emitting direction D of the laser diode 310 is approximately 45 degrees, light beams emitted from the laser diode 310, after being reflected by the sidewall 324, become the planar surrounding light 350 distributed in a horizontal plane. After the planar surrounding light 350 distributed in a horizontal plane irradiates on one of the reflective surfaces 124 shown in FIG. 1A, the laser ring 160 shown in FIG. 2 is obtained.

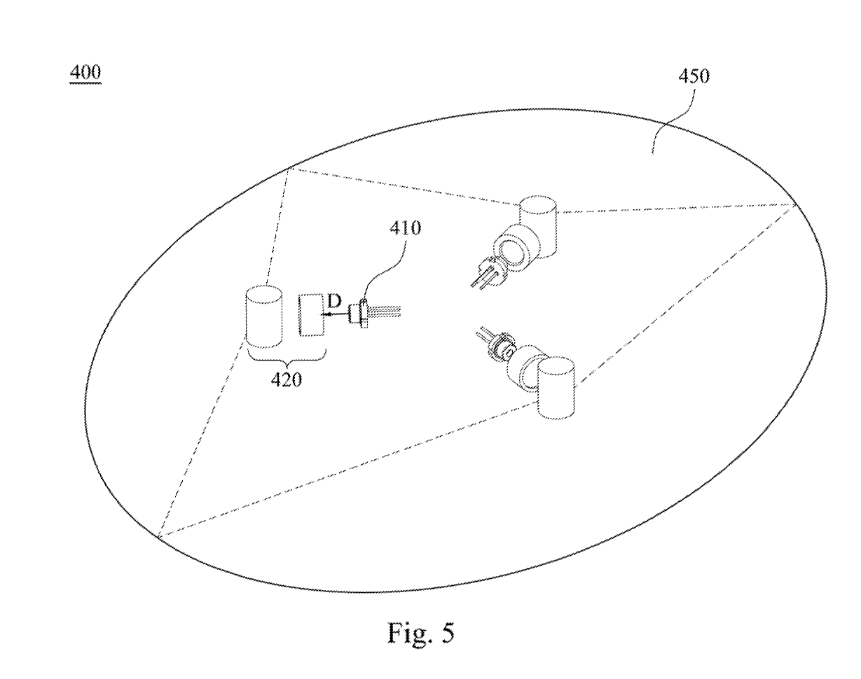

FIG. 5 is a schematic diagram of a laser plane source of a laser emitting device according to still another embodiment of this invention. The laser plane source 400 comprises a plurality of laser diodes 410 and a plurality of diverging devices 420. The laser diodes 410 are radially disposed. Each of the laser diodes 410 emits laser beams along its respective light-emitting direction D. The light-emitting direction D of the laser diodes 410 is approximately perpendicular to the normal direction N shown in FIG. 1A. A number of the laser diodes 410 is, for example, three according to the present embodiment, and each of the laser diodes 410 is placed at an angle of approximately 120 degrees relative to the other laser diodes 410. However, the laser beams emitted from the laser diodes 410 are approximately on the same plane.

The diverging devices 420 are disposed in light-emitting paths of the laser diodes 410 correspondingly to expand the beam angle emitted from the laser diodes 410. Thus, the laser beams emitted from the laser diodes 410 will have a larger divergent angle after passing through the diverging devices 420. The diverging devices 420 and the laser diodes 410 are coplanar to allow the light beams emitted from the laser diodes 410 to constitute planar surrounding light 450 after passing through the diverging devices 420. The planar surrounding light 450 is approximately distributed in a horizontal plane.

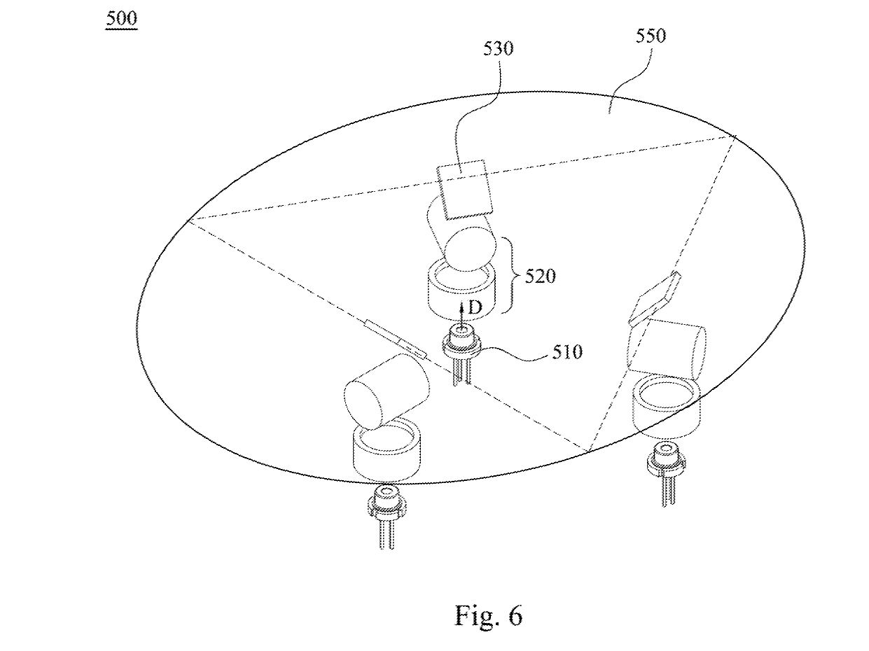

FIG. 6 is a schematic diagram of a laser plane source of a laser emitting device according to yet another embodiment of this invention. The laser plane source 500 comprises a plurality of laser diodes 510, a plurality of diverging devices 520 disposed corresponding to the laser diodes 520, and a plurality of reflective mirrors 530 disposed corresponding to the diverging devices 520. Light beams emitted from the laser diodes 510 will constitute planar surrounding light 550 after passing through the diverging devices 520 and the reflective mirrors 530.

In the present embodiment, a light-emitting direction D of the plurality of laser diodes 510 is approximately parallel with the normal direction N shown in FIG. 1A. The diverging devices 520 and the reflective mirrors 530 are disposed in the light-emitting direction D of the laser diodes 510 correspondingly. Thus, laser beams emitted from the laser diodes 510 will have a larger divergent angle after passing through the diverging devices 520. After that, the laser beams having the larger divergent angle are reflected by the reflective mirrors 530 to allow the reflected laser beams to constitute the planar surrounding light 550 distributed in a horizontal plane.

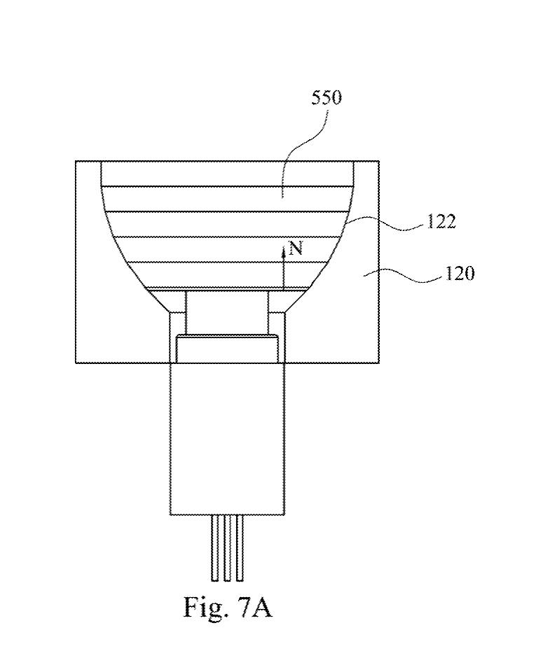

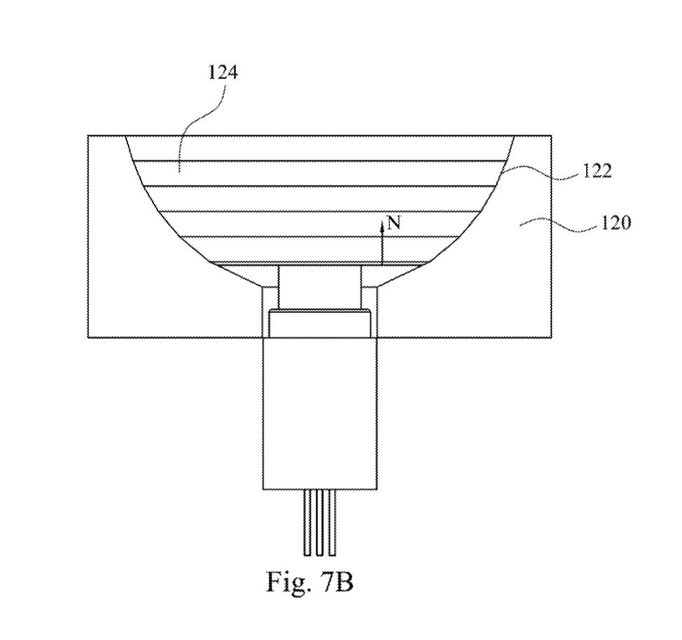

FIG. 7A and FIG. 7B are schematic cross-sectional views of the reflector 120 of the laser emitting device in FIG. 1A according to different embodiments of this invention. The reflective sidewall 122 of the reflector 120 has the plurality of reflective surfaces 124 connected to each other. Each of the reflective surfaces 124 has an individual angle relative to the normal direction N. For example, the angles between the reflective surfaces 124 and the normal direction N may gradually decrease from one end adjacent to the laser plane source 110 to the other end, as shown in FIG. 7A. Or, the angles between the reflective surfaces 124 and the normal direction N may gradually increase from the end adjacent to the laser plane source 110 to the other end.

When light emitted from the laser plane source irradiates on the different reflective surfaces 124, the laser ring will have different sizes. In addition, a reflective path of the planar surrounding light will also differ due to the different angles of the reflective surfaces 124. Reference is made to the following description and accompany drawings for specific illustration.

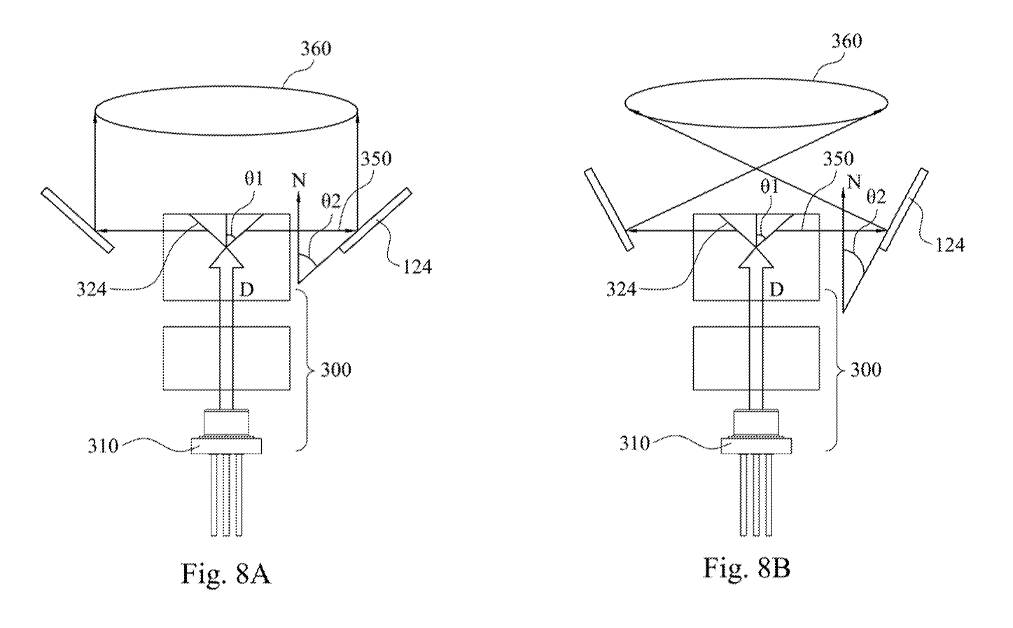

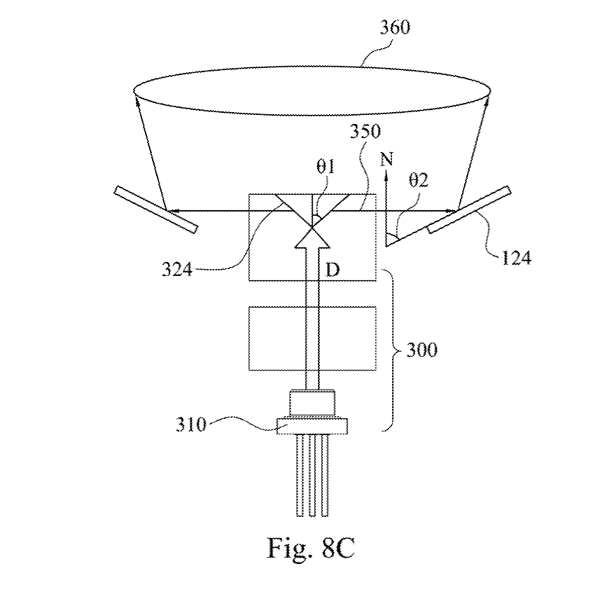

FIG. 8A to FIG. 8C are schematic diagrams of optical paths when planar surrounding light in a laser emitting device irradiates on reflective surfaces having different angles according to this invention. To simplify matters, reference is made to the laser plane source shown in FIG. 4 for explanation of the present embodiment laser emitting device, and only the reflective surface hit by the planar surrounding light is depicted in the drawings.

The planar surrounding light 350 emitted from the laser plane source 300 is distributed in a horizontal plane. The planar surrounding light 350 has a normal direction N. The laser diode 310 has the light-emitting direction D, and the light-emitting direction D is approximately parallel with the normal direction N.

As shown in FIG. 8A, an angle between the light-emitting direction D of the laser diode 310 and the sidewall 324 is θ₁, an angle between the reflective surface 124 and the normal direction N is θ₂, and θ₁ is approximately equal to θ₂ that is 45 degrees. Under the circumstances, the planar surrounding light 350 is reflected by the reflective surface 124 and forms a laser ring 360. Furthermore, the laser ring 360 is essential parallel light beams, and a diameter of the laser ring 360 will not vary with the projection distance.

As shown in FIG. 8B, the angle between the light-emitting direction D of the laser diode 310 and the sidewall 324 is θ₁, the angle between the reflective surface 124 and the normal direction N is θ₂, and θ₂ is smaller than θ₁. Under the circumstances, after the planar surrounding light 350 irradiates on the reflective surface 124, the planar surrounding light 350 is first reflected toward the center to focus and then diverges. In this manner, the diameter of laser ring 360 varies with the projection distance.

As shown in FIG. 8C, the angle between the light-emitting direction D of the laser diode 310 and the sidewall 324 is θ₁, the angle between the reflective surface 124 and the normal direction N is θ₂, and θ₂ is greater than θ₁. Under the circumstances, after the planar surrounding light 350 irradiates on the reflective surface 124, the planar surrounding light 350 will divert outwardly. In this manner, the diameter of laser ring 360 varies with the projection distance.

Although the planar surrounding light distributed in a horizontal plane is shown by way of illustration in the above-mentioned embodiments, however in practical applications, the planar surrounding light may be in a conical shape.

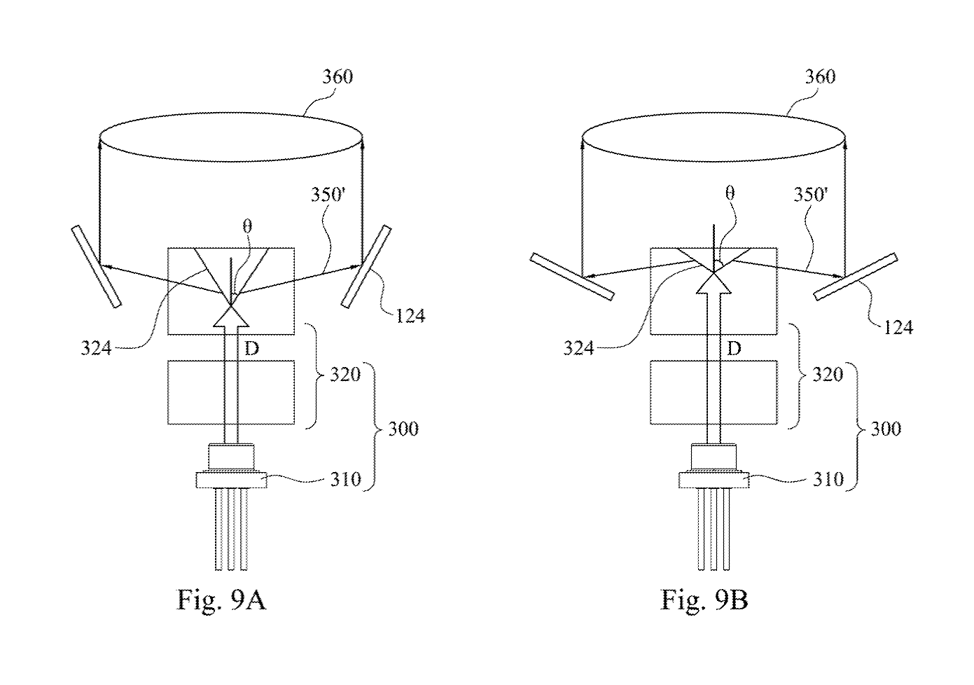

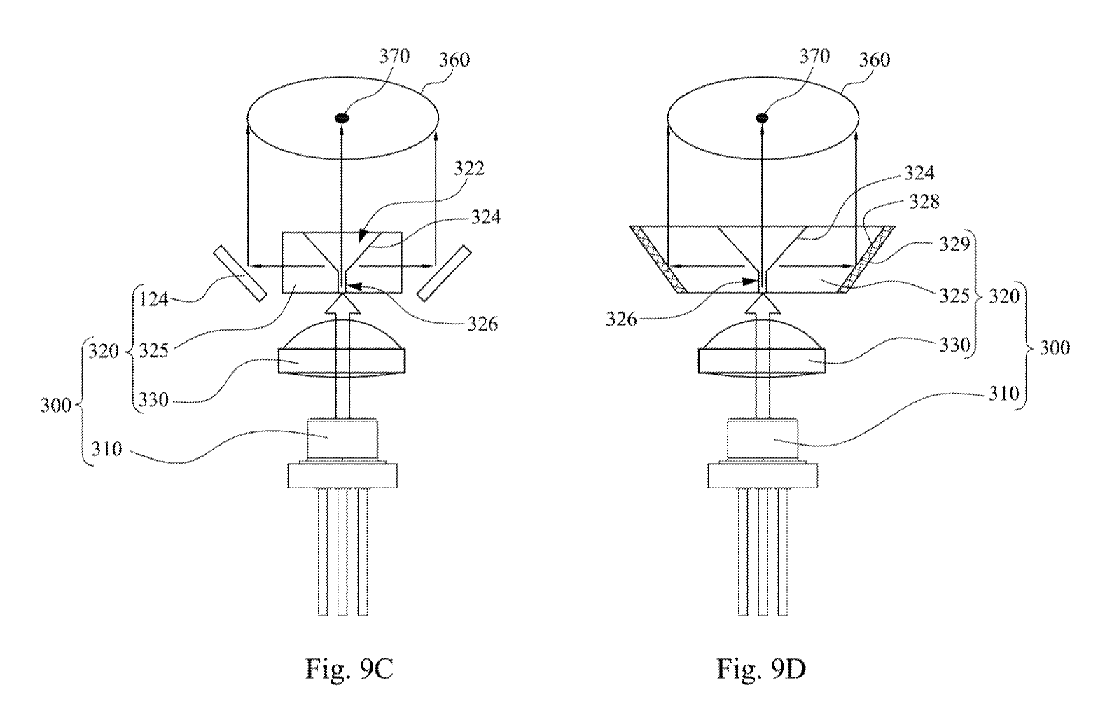

FIG. 9A to FIG. 9D are schematic diagrams of the laser plane source 300 in FIG. 4 according to different embodiments. To simplify matters, reference is made to the laser plane source shown in FIG. 4 for explanation of the present embodiment laser emitting device and only the reflective surface hit by the planar surrounding light is depicted in the drawings.

As shorn in FIG. 9A and FIG. 9B, even though the angle θ between the sidewall 324 of the optical device 320 and the light-emitting direction D of the laser diode 310 is smaller than 45 degrees (see FIG. 9A) or greater than 45 degrees (see FIG. 9B) so that the planar surrounding light 350′ is in a conical shape, the planar surrounding light will still form the laser ring 360 which can be either parallel or divergent light beams after irradiating on the reflective surfaces 124.

Also, FIG. 9C and FIG. 9D show different embodiments of the laser plane source 300. As shown in FIG. 9C, the laser plane source 300 includes a laser diode 310, a collimating lens 330, a reflective lens 325, and a reflective surface 124. The collimating lens 330 is disposed between the reflective lens 325 and the laser diode 310. The reflective lens 325 includes a cone cavity 322, and a hole 326 arranged at a center of the bottom of the reflective lens 325, in which the hole 326 is led to the cone cavity 322. A part of the laser beams emitted from the laser diode 310 irradiate on the sidewall 324 and then are reflected by the reflective surface 124 to form laser ring 360. Another part of the laser beams pass through the hole 326 and emit directly to form a laser spot 370.

As shown in FIG. 9D, the difference between this embodiment and previous embodiments is that the reflective lens 325 has an inclined side surface 328, and the reflective surface is a reflective layer 329 coated on the inclined side surface of the reflective lens 325. Also, a part of the laser beams emitted from the laser diode 310 irradiate on the sidewall 324 and then are reflected by the reflective layer 329 to form laser ring 360, another part of the laser beams pass through the hole 326 and emit directly to form a laser spot 370. However, the size of the laser ring 360 cannot be changed in this embodiment. The laser plane source 300 disclosed in FIG. 9D can be utilized as the laser emitting device individually for emitting both laser ring 360 and the laser spot 370.

The present invention laser emitting device can be used alone, or a combination of a plurality of laser emitting devices can be used. The laser emitting device may be applied to lighting apparatuses, such as lamps and lanterns, decorative lights, or electric hand torches. The laser emitting device may also be applied to laser pointers to resolve the problem that a bright beam spot blocks clear viewing of aimed objects hen the projection distance increases which always happens in the prior art laser pointer. The laser emitting device may also be applied to warning devices. For example, the laser emitting device may be applied to a bicycle so as to project a laser ring having the same width or length as that of the bicycle on the ground. As a result, vehicle drivers are thus alerted to the presence of bicycle rider when driving at night.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. A laser emitting device comprising:
a laser plane source providing planar surrounding light, the planar surrounding light having a normal direction;
a reflector surrounding the laser plane source, the reflector having a reflective sidewall facing the laser plane source, the reflective sidewall comprising a plurality of reflective surfaces connected to each other, and each of the reflective surfaces having an individual angle relative to the normal direction; and
a connection mechanism to allow the reflector to be moved relative to the laser plane source along the normal direction.

2. The laser emitting device of claim 1, wherein the laser plane source comprises a laser diode and a cone lens disposed in a light-emitting direction of the laser diode.

3. The laser emitting device of claim 1, wherein the laser plane source comprises a laser diode and an optical device, the optical device comprises a cone cavity.

4. The laser emitting device of claim 1, wherein the laser plane source comprises:
a plurality of laser diodes; and
a plurality of diverging devices disposed corresponding to the plurality of laser diodes, the plurality of diverging devices and the plurality of laser diodes are coplanar to allow light beams emitted from the plurality of laser diodes to constitute the planar surrounding light after passing through the plurality of diverging devices.

5. The laser emitting device of claim 1, wherein the laser plane source comprises:
a plurality of laser diodes;
a plurality of diverging devices disposed corresponding to the plurality of laser diodes; and
a plurality of reflective mirrors disposed corresponding to the plurality of diverging devices to allow light beams emitted from the plurality of laser diodes to constitute the planar surrounding light after passing through the plurality of diverging devices and the plurality of reflective mirrors.

6. The laser emitting device of claim 1, wherein the angles between the plurality of reflective surfaces and the normal direction gradually increase from one end adjacent to the laser plane source to the other end.

7. The laser emitting device of claim 1, wherein the angles between the plurality of reflective surfaces and the normal direction gradually decrease from one end adjacent to the laser plane source to the other end.

8. The laser emitting device of claim 1, further comprising:
a housing having a battery receiving cavity;
a partition board covering the battery receiving cavity; and
a conductive spring disposed on a surface of the partition board facing the battery receiving cavity, the laser plane source being fixed on another surface of the partition board and electrically connected to the conductive spring.

9. The laser emitting device of claim 8, wherein the connection mechanism slidably connects the reflector and the housing.

10. The laser emitting device of claim 1, wherein the laser emitting device is a lighting apparatus, a laser pointer, or a warning device.

11. The laser emitting device of claim 1, wherein the reflector is in a shape of a cup.

12. The laser emitting device of claim 1, wherein the planar surrounding light is distributed in a horizontal plane.

13. The laser emitting device of claim 1, wherein the laser plane source comprises:
a laser diode;
a reflective lens comprising a cone cavity, and a hole formed at a center of a bottom of the reflective lens, wherein the hole is led to the cone cavity; and
a collimating lens disposed between the laser diode and the reflective lens.

14. A laser emitting device, comprising:
a laser diode;
a reflective lens comprising:
a cone cavity;
a hole formed at a center of a bottom of the reflective lens, wherein the hole is led to the cone cavity;
an inclined side surface; and
a reflective layer coated on the inclined side surface; and
a collimating lens disposed between the laser diode and the reflective lens.

15. A laser emitting device comprising:
a laser plane source providing planar surrounding light;
a reflector surrounding the laser plane source, the reflector having a reflective sidewall facing the laser plane source, the reflective sidewall comprising a plurality of reflective surfaces connected to each other, each of the reflective surfaces having an individual angle relative to the planar surrounding light, and the planar surrounding light hitting one of the reflective surfaces and forming a laser ring emitted from the laser emitting device; and
a connection mechanism to allow the reflector to be moved relative to the laser plane source, and a diameter of the laser ring being changed by changing the reflective surface to be hit by the planar surrounding light.

16. The laser emitting device of claim 15, wherein the planar surrounding light distributed in a horizontal plane.

17. The laser emitting device of claim 15, wherein the planar surrounding light is in a conical shape.

18. A laser emitting device comprising:
a laser plane source providing planar surrounding light;
a reflector surrounding the laser plane source, the reflector having a reflective sidewall facing the laser plane source, the reflective sidewall comprising a reflective surface having an angle relative to the planar surrounding light, and the planar surrounding light hitting the reflective surface and forming a laser ring emitted from the laser emitting device; and
a connection mechanism for connecting the laser plane source to the reflector.
